(19) United States
(12) Patent Application Publication
(10) Pub. No.: US 2024/0306729 A1
(43) Pub. Date: Sep. 19, 2024

(54) MULTIPLE-TEMPERATURE MONITORING FOR AN AEROSOL PROVISION SYSTEM

(71) Applicant: RAI Strategic Holdings, Inc., Winston-Salem, NC (US)

(72) Inventor: Sean A. Daugherty, Yadkinville, NC (US)

(21) Appl. No.: 18/183,615

(22) Filed: Mar. 14, 2023

(51) Int. Cl. A24F 40/57; A24F 40/51; A24F 40/53; A24F 40/95

(52) U.S. Cl. CPC A24F 40/57; A24F 40/51; A24F 40/53; A24F 40/95; A24F 40/40

(57) ABSTRACT

An aerosol provision device is provided having a power source including a first temperature sensor, processing circuitry including a second temperature sensor, and a use sensor including a third temperature sensor. A temperature of the aerosol provision device may be determined based on at least two of: the temperature measured by the first temperature sensor, the temperature measured by the second temperature sensor, and the temperature measures by the third temperature sensor, and at least one device function may be controlled based on the determined temperature of the aerosol provision device, and at least one threshold temperature.

### TECHNOLOGICAL FIELD

The present disclosure relates to aerosol provision systems such as smoking articles designed to deliver at least one substance to a user.

### BACKGROUND

Many aerosol provision systems and in particular non-combustible aerosol provision systems have been proposed through the years as improvements upon, or alternatives to, smoking products that require combusting tobacco for use. These systems are generally designed to deliver at least one substance to a user, such as to satisfy a particular “consumer moment.” To this end, the substance may include constituents that impart a physiological effect on the user, a sensorial effect on the user, or both. The substance may be generally present in an aerosol-generating material that may contain one or more constituents of a range of constituents, such as active substances, flavors, aerosol-former materials and other functional materials like fillers.

Aerosol provision systems include, for example, vapor products commonly known as “electronic cigarettes,” “e-cigarettes” or electronic nicotine delivery systems (ENDS), as well as heat-not-burn products including tobacco heating products (THPs) and carbon-tipped tobacco heating products (CTHPs). Many of these products take the form of a system including a device and a consumable, and it is the consumable that includes the material from which the substance to be delivered originates. Typically, the device is reusable, and the consumable is single-use (although some consumables are refillable). Therefore, in many cases, the consumable is sold separately from the device, and often in a multipack. Moreover, subsystems and some individual components of devices or consumables may be sourced from specialist manufacturers.

### BRIEF SUMMARY

Example implementations of the present disclosure are directed to an aerosol provision device with a power source, processing circuitry, and a use sensor that include respective temperature sensors from which temperatures at the power source, processing circuitry, and use sensor are measurable. The temperatures at the power source, processing circuitry, and use sensor are measured, and a temperature of the device may be determined from at least two of the temperatures. At least one device function may be controlled based on the determined temperature of the device. The present disclosure includes, without limitation, the following example implementations.

Some example implementations provide an aerosol provision device comprising a power source including a first temperature sensor with which a temperature at the power source is measurable; an aerosol generator powered by the power source to generate an aerosol from an aerosol-generating material for delivery to a user; processing circuitry configured to control power to the aerosol generator, the processing circuitry including a second temperature sensor with which the temperature at the processing circuitry is measurable, a use sensor configured to detect a draw on the device, the use sensor including a third temperature sensor with which temperature at the use sensor is measurable, the processing circuitry further configured to at least: measure the temperature at the power source using the first temperature sensor, measure the temperature at the processing circuitry using the second temperature sensor, and measure the temperature at the use sensor using the third temperature sensor; determine a temperature of the aerosol provision device based on at least two of the temperature at the power source, the temperature at the processing circuitry, and the temperature at the use sensor; and control at least one device function based on the determined temperature of the aerosol provision device, and at least one threshold temperature.

Some example implementations provide a method of operating an aerosol provision device, the method comprising controlling power from a power source to an aerosol generator to generate an aerosol from the aerosol-generating material for delivery to a user, the power source including a first temperature sensor with which a temperature at the power source is measurable, the power controlled by processing circuitry including a second temperature sensor with which the temperature at the processing circuitry is measurable; and further by the processing circuitry, the aerosol provision device further including a use sensor configured to detect a change in pressure as the user draws on the device, the use sensor including a third temperature sensor with which temperature at the use sensor is measurable, measuring a temperature at the power source using the first temperature sensor, measuring a temperature at the processing circuitry using the second temperature sensor, and measuring a temperature at the use sensor using the third temperature sensor, determining a temperature of the aerosol provision device based on at least two of the temperature at the power source, the temperature at the processing circuitry, and the temperature at the use sensor; and controlling at least one device function based on the determined temperature of the aerosol provision device, and at least one threshold temperature.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above-described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURES

Having thus described aspects of the disclosure in the foregoing general terms, reference will now be made to the accompanying figures, which are not necessarily drawn to scale, and wherein:

FIG. 1 is a block diagram of an aerosol provision system according to some example implementations of the present disclosure;

FIGS. 2 and 3 illustrate an aerosol provision system in the form of a vapor product, according to some example implementations;

FIG. 4 illustrates a nebulizer that may be used to implement an aerosol generator of an aerosol provision system, according to some example implementations;

FIGS. 5, 6 and 7 illustrate an aerosol provision system in the form of a heat-not-burn product, according to some example implementations;

FIG. 8 further illustrates circuitry of the aerosol provision device of FIG. 1, according to some example implementations; and

FIGS. 9A, 9B, 9C, 9D and 9E are flowcharts illustrating various steps in a method of operating an aerosol provision device, according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure are generally directed to delivery systems designed to deliver at least one substance to a user, such as to satisfy a particular “consumer moment.” The substance may include constituents that impart a physiological effect on the user, a sensorial effect on the user, or both.

Delivery systems may take many forms. Examples of suitable delivery systems include aerosol provision systems such as powered aerosol provision systems designed to release one or more substances or compounds from an aerosol-generating material without combusting the aerosol-generating material. These aerosol provision systems may at times be referred to as non-combustible aerosol provision systems, aerosol delivery devices or the like, and the aerosol-generating material may be, for example, in the form of a solid, semi-solid, liquid or gel and may or may not contain nicotine.

Examples of suitable aerosol provision systems include vapor products, heat-not-burn products, hybrid products and the like. Vapor products are commonly known as “electronic cigarettes,” “e-cigarettes” or electronic nicotine delivery systems (ENDS), although the aerosol-generating material need not include nicotine. Many vapor products are designed to heat a liquid material to generate an aerosol. Other vapor products are designed to break up an aerosol-generating material into an aerosol without heating, or with only secondary heating. Heat-not-burn products include tobacco heating products (THPs) and carbon-tipped tobacco heating products (CTHPs), and many are designed to heat a solid material to generate an aerosol without combusting the material.

Hybrid products use a combination of aerosol-generating materials, one or a plurality of which may be heated. Each of the aerosol-generating materials may be, for example, in the form of a solid, semi-solid, liquid, or gel. Some hybrid products are similar to vapor products except that the aerosol generated from a liquid or gel aerosol-generating material passes through a second material (such as tobacco) to pick up additional constituents before reaching the user. In some example implementations, the hybrid system includes a liquid or gel aerosol-generating material, and a solid aerosol-generating material. The solid aerosol-generating material may include, for example, tobacco or a non-tobacco product.

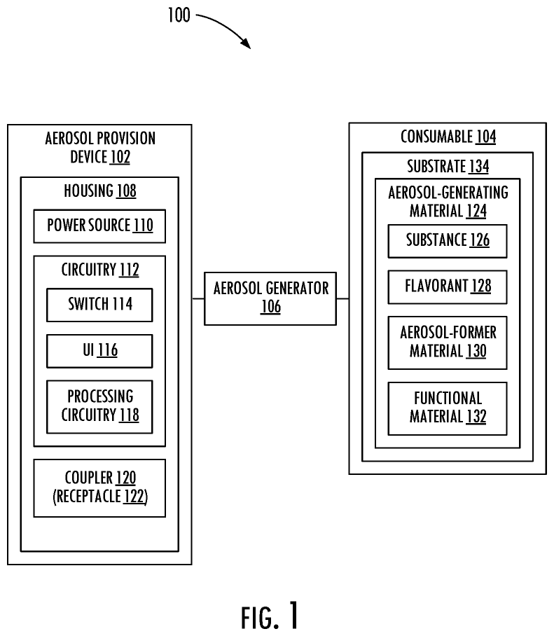

FIG. 1 is a block diagram of an aerosol provision system 100 according to some example implementations. In various examples, the aerosol provision system may be a vapor product, heat-not-burn product or hybrid product. The aerosol provision system includes one or more of each of a number of components including, for example, an aerosol provision device 102, and a consumable 104 (sometimes referred to as an article) for use with the aerosol provision device. The aerosol provision system also includes an aerosol generator 106. In various implementations, the aerosol generator may be part of the aerosol provision device or the consumable. In other implementations, the aerosol generator may be separate from the aerosol provision device and the consumable, and removably engaged with the aerosol provision device and/or the consumable.

In various examples, the aerosol provision system 100 and its components including the aerosol provision device 102 and the consumable 104 may be reusable or single-use. In some examples, the aerosol provision system including both the aerosol provision device and the consumable may be single use. In some examples, the aerosol provision device may be reusable, and the consumable may be reusable (e.g., refillable) or single use (e.g., replaceable). In yet further examples, the consumable may be both refillable and also replaceable. In examples in which the aerosol generator 106 is part of the aerosol provision device or the consumable, the aerosol generator may be reusable or single-use in the same manner as the aerosol provision device or the consumable.

In some example implementations, the aerosol provision device 102 may include a housing 108 with a power source 110 and circuitry 112. The power source is configured to provide a source of power to the aerosol provision device and thereby the aerosol provision system 100. The power source may be or include, for example, an electric power source such as a non-rechargeable battery or a rechargeable battery, solid-state battery (SSB), lithium-ion battery, supercapacitor, or the like.

The circuitry 112 may be configured to enable one or more functionalities (at times referred to as services) of the aerosol provision device 102 and thereby the aerosol provision system 100. The circuitry includes electronic components, and in some examples one or more of the electronic components may be formed as a circuit board such as a printed circuit board (PCB).

In some examples, the circuitry 112 includes at least one switch 114 that may be directly or indirectly manipulated by a user to activate the aerosol provision device 102 and thereby the aerosol provision system 100. The switch may be or include a pushbutton, touch-sensitive surface or the like that may be operated manually by a user. Additionally or alternatively, the switch may be or include a sensor configured to sense one or more process variables that indicate use of the aerosol provision device or aerosol provision system, such as, for example, a draw on the device. Examples include a flow sensor, pressure sensor, pressure switch or the like that is configured to detect airflow or a change in pressure caused by airflow when a user draws on the consumable 104.

The switch 114 may provide user interface functionality. In some examples, the circuitry 112 may include a user interface (UI) 116 that is separate from or that is or includes the switch. The UI may include one or more input devices and/or output devices to enable interaction between the user and the aerosol provision device 102. As described above with respect to the switch, examples of suitable input devices include pushbuttons, touch-sensitive surfaces and the like. The one or more output devices generally include devices configured to provide information in a human-perceptible form that may be visual, audible or tactile/haptic. Examples of suitable output devices include light sources such as light-emitting diodes (LEDs), quantum dot-based LEDs and the like. Other examples of suitable output devices include display devices (e.g., electronic visual displays), touchscreens (integrated touch-sensitive surface and display device), loudspeakers, vibration motors and the like.

In some examples, the circuitry 112 includes processing circuitry 118 configured to perform data processing, application execution, or other processing, control or management services according to one or more example implementations. The processing circuitry may include a processor embodied in a variety of forms such as at least one processor core, microprocessor, coprocessor, controller, microcontroller or various other computing or processing devices including one or more integrated circuits such as, for example, an ASIC (application specific integrated circuit), an FPGA (field programmable gate array), some combination thereof, or the like. In some examples, the processing circuitry may include memory coupled to or integrated with the processor, and which may store data, computer program instructions executable by the processor, some combination thereof, or the like.

As also shown, in some examples, the housing 108 and thereby the aerosol provision device 102 may also include a reservoir and/or coupler 120, which in some implementations may comprise a receptacle 122 structured to engage and hold the consumable 104, and thereby couple the aerosol provision device with the consumable. In some implementations, the coupler may be or include a connector, fastener or the like that is configured to connect with a corresponding coupler of the consumable, such as by a press fit (or interference fit) connection, threaded connection, magnetic connection or the like. In some implementations, the receptacle may be or include a reservoir, tank, container, cavity, receiving chamber or the like that is structured to receive and contain the consumable or at least a portion of the consumable. In other implementations, the reservoir may contain an aerosol-generating material, such as, for example, a liquid reservoir that contains a liquid aerosol-generating material. In some implementations, the reservoir may include a substrate that may contain an aerosol-generating material. In some implementations, the reservoir may be integral with the device, and in some implementations, the device may be disposable.

The consumable 104 is an article including aerosol-generating material 124 (also referred to as an aerosol precursor composition), part or all of which is intended to be consumed during use by a user. The aerosol provision system 100 may include one or more consumables, and each consumable may include one or more aerosol-generating materials. In some examples in which the aerosol provision system is a hybrid product, the aerosol provision system may include a liquid or gel aerosol-generating material to generate an aerosol, which may then pass through a second, solid aerosol-generating material to pick up additional constituents before reaching the user. These aerosol-generating materials may be within a single consumable or respective consumables that may be separately removable.

The aerosol-generating material 124 is capable of generating aerosol, for example when heated, irradiated or energized in any other way. The aerosol-generating material may be, for example, in the form of a solid, semi-solid, liquid or gel. The aerosol-generating material may include an “amorphous solid,” which may be alternatively referred to as a “monolithic solid” (i.e., non-fibrous). In some examples, the amorphous solid may be a dried gel. The amorphous solid is a solid material that may retain some fluid, such as liquid, within it. In some examples, the aerosol-generating material may include from about 50 wt %, 60 wt % or 70 wt % of amorphous solid, to about 90 wt %, 95 wt % or 100 wt % of amorphous solid.

The aerosol-generating material 124 may include one or more of each of a number of constituents such as an active substance 126, flavorant 128, aerosol-former material 130 or other functional material 132.

The active substance 126 may be a physiologically active material, which is a material intended to achieve or enhance a physiological response such as improved alertness, improved focus, increased energy, increased stamina, increased calm or improved sleep. The active substance may for example be selected from nutraceuticals, nootropics, psychoactives. The active substance may be naturally occurring or synthetically obtained. The active substance may include, for example, nicotine, caffeine, GABA (γ-aminobutyric acid), L-theanine, taurine, theine, vitamins such as B6 or B12 (cobalamin) or C, melatonin, cannabinoids, terpenes, or constituents, derivatives, or combinations thereof. The active substance may include one or more constituents, derivatives or extracts of tobacco, cannabis or another botanical.

In some examples in which the active substance 126 includes derivatives or extracts, the active substance may be or include one or more cannabinoids or terpenes.

As noted herein, the active substance 126 may include or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may include an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens.

In yet other examples, the active substance 126 may be or include one or more of 5-hydroxytryptophan (5-HTP)/oxitriptan/Griffonia simplicifolia, acetylcholine, arachidonic acid (AA, omega-6), ashwagandha (Withania somnifera), Bacopa monniera, beta alanine, beta-hydroxy-beta-methylbutyrate (HMB), Centella asiatica, chai-hu, cinnamon, citicoline, cotinine, creatine, curcumin, docosahexaenoic acid (DHA, omega-3), dopamine, Dorstenia arifolia, Dorstenia Odorata, essential oils, GABA, Galphimia glauca, glutamic acid, hops, kaempferia parviflora (Thai ginseng), kava, L-carnitine, L-arginine, lavender oil, L-choline, liquorice, L-lysine, L-theanine, L-tryptophan, lutein, magnesium, magnesium L-threonate, myo-inositol, nardostachys chinensis, nitrate, oil-based extract of Viola odorata, oxygen, phenylalanine, phosphatidylserine, quercetin, resveratrol, Rhizoma gastrodiae, Rhodiola, Rhodiola rosea, rose essential oil, S-adenosylmethionine (SAMe), sceletium tortuosum, schisandra, selenium, serotonin, skullcap, spearmint extract, spikenard, theobromine, tumaric, Turnera aphrodisiaca, tyrosine, vitamin A, vitamin B3, or yerba mate.

In some example implementations, the aerosol-generating material 124 includes a flavorant 128. As used herein, the terms “flavorant” and “flavor” refer to materials which, where local regulations permit, may be used to create a desired taste, aroma or other somatosensorial sensation in a product for adult consumers. Flavorants may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, redberry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. Flavorants may be imitation, synthetic or natural ingredients or blends thereof. Flavorants may be in any suitable form, for example, liquid such as an oil, solid such as a powder, or gas.

In some example implementations, the flavorant 128 may include a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material 130 may include one or more constituents capable of forming an aerosol. In some example implementations, the aerosol-former material may include one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials 132 may include one or more of pH regulators, colouring agents, preservatives, binders, fillers, stabilizers, and/or antioxidants. Suitable binders include, for example, pectin, guar gum, fruit pectin, citrus pectin, tobacco pectin, hydroxyethyl guar gum, hydroxypropyl guar gum, hydroxyethyl locust bean gum, hydroxypropyl locust bean gum, alginate, starch, modified starch, derivatized starch, methyl cellulose, ethyl cellulose, ethylhydroxymethyl cellulose, carboxymethyl cellulose, tamarind gum, dextran, pullalon, konjac flour or xanthan gum.

In some example implementations, the aerosol-generating material 124 may be present on or in a support to form a substrate 134. The support may be or include, for example, paper, card, paperboard, cardboard, reconstituted material (e.g., a material formed from reconstituted plant material, such as reconstituted tobacco, reconstituted hemp, etc.), a plastics material, a ceramic material, a composite material, glass, a metal, or a metal alloy. In some examples, the support includes a susceptor, which may be embedded within the aerosol-generating material, or on one or either side of the aerosol-generating material.

Although not separately shown, in some example implementations, the consumable 104 may further include receptacle structured to engage and hold the aerosol-generating material 124, or substrate 134 with the aerosol-generating material. The receptacle may be or include a reservoir, tank, container, cavity, receiving chamber or the like that is structured to receive and contain the aerosol-generating material or the substrate. The consumable may include an aerosol-generating material transfer component (also referred to as a liquid transport element) configured to transport aerosol-generating material to the aerosol generator 106. The aerosol-generating material transfer component may be adapted to wick or otherwise transport aerosol-generating material via capillary action. In some examples, the aerosol-generating material transfer component may include a microfluidic chip, a micro pump or other suitable component to transport aerosol-generating material.

The aerosol generator 106 (also referred to as an atomizer, aerosolizer or aerosol production component) is configured to energize the aerosol-generating material 124, directly or indirectly, to generate an aerosol, or otherwise cause generation of an aerosol from the aerosol-generating material. More particularly, in some examples, the aerosol generator may be powered by the power source 110 under control of the circuitry 112 to generate an aerosol from the aerosol-generating material.

In some example implementations, the aerosol generator 106 is an electric heater configured to perform electric heating in which electrical energy from the power source is converted to heat energy, which the aerosol-generating material is subject to so as to release one or more volatiles from the aerosol-generating material to form an aerosol. Examples of suitable forms of electric heating include resistance (Joule) heating, induction heating, dielectric and microwave heating, radiant heating, arc heating and the like. More particular examples of suitable electric heaters include resistive heating elements such as wire coils, flat plates, prongs, micro heaters or the like.

In some example implementations, the aerosol generator 106 is configured to cause an aerosol to be generated from the aerosol-generating material without heating, or with only secondary heating. For example, the aerosol generator may be configured to subject the aerosol-generating material to one or more of increased pressure, vibration, or electrostatic energy. More particular examples of these aerosol generators include jet nebulizers, ultrasonic wave nebulizers, vibrating mesh technology (VMT) nebulizers, surface acoustic wave (SAW) nebulizers, and the like.

A jet nebulizer is configured to use compressed gas (e.g., air, oxygen) to break up aerosol-generating material 124 into an aerosol, and an ultrasonic wave nebulizer is configured to use ultrasonic waves to break up aerosol-generating material into an aerosol. A VMT nebulizer includes a mesh, and a piezo material (e.g., piezoelectric material, piezomagnetic material) that may be driven to vibrate and cause the mesh to break up aerosol-generating material into an aerosol. A SAW nebulizer is configured to use surface acoustic waves or Rayleigh waves to break up aerosol-generating material into an aerosol.

In some examples, the aerosol generator 106 may include a susceptor, or the susceptor may be part of the substrate 134. The susceptor is a material that is heatable by penetration with a varying magnetic field generated by a magnetic field generator that may be separate from or part of the aerosol generator. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor in some examples may be both electrically-conductive and magnetic, so that the susceptor of these examples is heatable by both heating mechanisms.

Although not separately shown, either or both the aerosol provision device 102 or the consumable 104 may include an aerosol-modifying agent. The aerosol-modifying agent is a substance configured to modify the aerosol generated from the aerosol-generating material 124, such as by changing the taste, flavor, acidity or another characteristic of the aerosol. In various examples, the aerosol-modifying agent may be an additive or a sorbent. The aerosol-modifying agent may include, for example, one or more of a flavorant, colorant, water or carbon adsorbent. The aerosol-modifying agent may be a solid, semi-solid, liquid or gel. The aerosol-modifying agent may be in powder, thread or granule form. The aerosol-modifying agent may be free from filtration material. In some examples, the aerosol-modifying agent may be provided in an aerosol-modifying agent release component, that is operable to selectively release the aerosol-modifying agent.

The aerosol provision system 100 and its components including the aerosol provision device 102, consumable 104, and aerosol generator 106 may be manufactured with any of a number of different form factors, and with additional or alternative components relative to those described above.

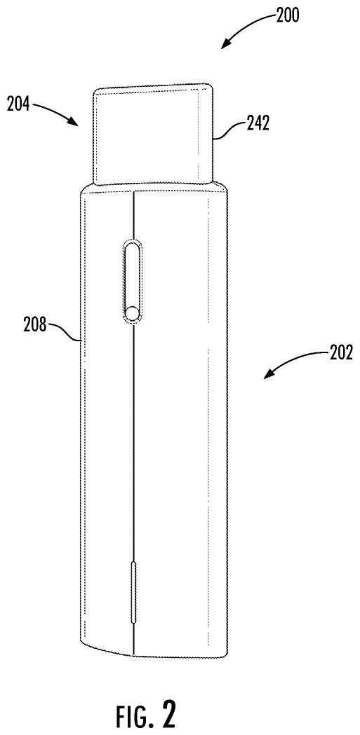

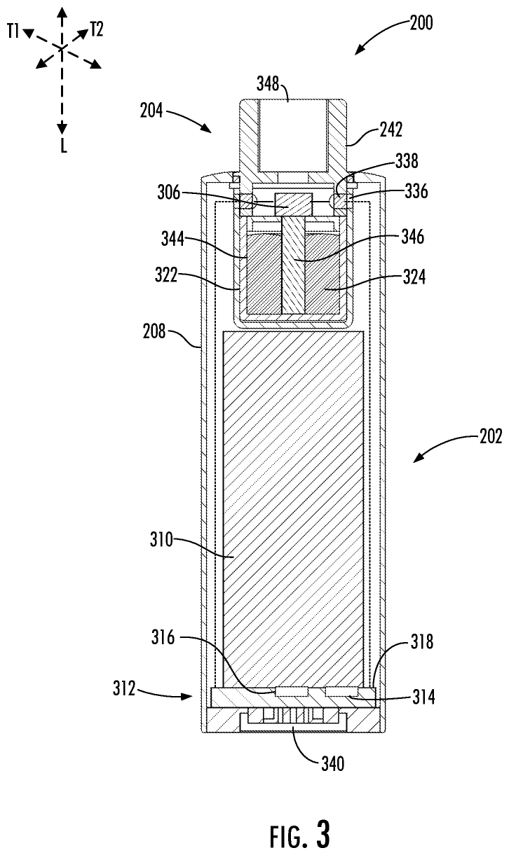

FIGS. 2 and 3 illustrate an aerosol provision system 200 in the form of a vapor product, and that in some example implementations may correspond to the aerosol provision system 100. As shown, the aerosol provision system 200 may include an aerosol provision device 202 (also referred to as a control body or power unit) and a consumable 204 (also referred to as a cartridge or tank), which may correspond to respectively the aerosol provision device 102 and the consumable 104. The aerosol provision system and in particular the consumable may also include an aerosol generator corresponding to the aerosol generator 106, and in the form of an electric heater 306 such as a heating element like a metal wire coil configured to convert electrical energy to heat energy through resistance (Joule) heating. The aerosol provision device and the consumable can be permanently or detachably aligned in a functioning relationship. FIGS. 2 and 3 illustrate respectively a perspective view and a partially cut-away side view of the aerosol provision system in a coupled configuration.

As seen in FIG. 2 and the cut-away view illustrated in FIG. 3, the aerosol provision device 202 and consumable 204 each include a number of respective components. The components illustrated in FIG. 3 are representative of the components that may be present in an aerosol provision device and consumable and are not intended to limit the scope of components that are encompassed by the present disclosure.

The aerosol provision device 202 may include a housing 208 (sometimes referred to as an aerosol provision device shell) that may include a power source 310. The housing may also include circuitry 312, which in some implementations may include a switch in the form of a sensor 314, a user interface including a light source 316 that may be illuminated with use of the aerosol provision system 200, and processing circuitry 318 (also referred to as a control component). The housing may also include a receptacle in the form of a consumable receiving chamber 322 structured to engage and hold the consumable 204. And the consumable may include an aerosol-generating material 324 that may correspond to aerosol-generating material 124, and that may include one or more of each of a number of constituents such as an active substance, flavorant, aerosol-former material or other functional material.

As also seen in FIG. 3, the aerosol provision device 202 may also include electrical connectors 336 positioned in the consumable receiving chamber 322 configured to electrically couple the circuitry and thereby the aerosol provision device with the consumable 204, and in particular electrical contacts 338 on the consumable. In this regard, the electrical connectors and electrical contacts may form a connection interface of the aerosol provision device and consumable. As also shown, the aerosol provision device may include an external electrical connector 340 to connect the aerosol provision device with one or more external devices. Examples of suitable external electrical connectors include USB connectors, proprietary connectors such as Apple's Lightning connector, and the like.

In various examples, the consumable 204 includes a tank portion and a mouthpiece portion. The tank portion and the mouthpiece portion may be integrated or permanently fixed together, or the tank portion may itself define the mouthpiece portion (or vice versa). In other examples, the tank portion and the mouthpiece portion may be separate and removably engaged with one another.

The consumable 204, tank portion and/or mouthpiece portion may be separately defined in relation to a longitudinal axis (L), a first transverse axis (T1) that is perpendicular to the longitudinal axis, and a second transverse axis (T2) that is perpendicular to the longitudinal axis and is perpendicular to the first transverse axis. The consumable can be formed of a housing 242 (sometimes referred to as the consumable shell) enclosing a reservoir 344 (in the tank portion) configured to retain the aerosol-generating material 324. In some examples, the consumable may include an aerosol generator, such as electric heater 306 in the illustrated example. In some examples, the electrical connectors 336 on the aerosol provision device 202 and electrical contacts 338 on the consumable may electrically connect the electric heater with the power source 310 and/or circuitry 312 of the aerosol provision device.

As shown, in some examples, the reservoir 344 may be in fluid communication with an aerosol-generating material transfer component 346 adapted to wick or otherwise transport aerosol-generating material 324 stored in the reservoir housing to the electric heater 306. At least a portion of the aerosol-generating material transfer component may be positioned proximate (e.g., directly adjacent, adjacent, in close proximity to, or in relatively close proximity to) the electric heater. The aerosol-generating material transfer component may extend between the electric heater and the aerosol-generating material stored in the reservoir, and at least a portion of the electric heater may be located above a proximal end the reservoir. For the purposes of the present disclosure, it should be understood that the term “above” in this particular context should be interpreted as meaning toward a proximal end of the reservoir and/or the consumable 204 in direction substantially along the longitudinal axis (L). Other arrangements of the aerosol-generating material transfer component are also contemplated within the scope of the disclosure. For example, in some example implementations, the aerosol-generating material transfer component may be positioned proximate a distal end of the reservoir and/or arranged transverse to the longitudinal axis (L).

The electric heater 306 and aerosol-generating material transfer component 346 may be configured as separate elements that are fluidly connected, the electric heater and aerosol-generating material transfer component or may be configured as a combined element. For example, in some implementations an electric heater may be integrated into an aerosol-generating material transfer component. Moreover, the electric heater and the aerosol-generating material transfer component may be formed of any construction as otherwise described herein. In some examples, a valve may be positioned between the reservoir 344 and electric heater, and configured to control an amount of aerosol-generating material 324 passed or delivered from the reservoir to the electric heater.

An opening 348 may be present in the housing 242 (e.g., at the mouth end of the mouthpiece portion) to allow for egress of formed aerosol from the consumable 204.

As indicated above, the circuitry 312 of the aerosol provision device 202 may include a number of electronic components, and in some examples may be formed of a circuit board such as a PCB that supports and electrically connects the electronic components. The sensor 314 (switch) may be one of these electronic components positioned on the circuit board. In some examples, the sensor may comprise its own circuit board or other base element to which it can be attached. In some examples, a flexible circuit board may be utilized. A flexible circuit board may be configured into a variety of shapes. In some examples, a flexible circuit board may be combined with, layered onto, or form part or all of a heater substrate.

In some examples, the reservoir 344 may be a container for storing the aerosol-generating material 324. In some examples, the reservoir may be or include a fibrous reservoir with a substrate with the aerosol-generating material present on or in a support. For example, the reservoir can comprise one or more layers of nonwoven fibers substantially formed into the shape of a tube encircling the interior of the housing 242, in this example. The aerosol-generating material may be retained in the reservoir. Liquid components, for example, may be sorptively retained by the reservoir. The reservoir may be in fluid connection with the aerosol-generating material transfer component 346. The aerosol-generating material transfer component may transport the aerosol-generating material stored in the reservoir via capillary action-or via a micro pump-to the electric heater 306. As such, the electric heater is in a heating arrangement with the aerosol-generating material transfer component.

In use, when a user draws on the aerosol provision system 200, airflow is detected by the sensor 314 (and/or a different use sensor, as described herein), and the electric heater 306 is activated to energize the aerosol-generating material 324 to generate an aerosol. Drawing upon the mouth end of the aerosol provision system causes ambient air to enter and pass through the aerosol provision system. In the consumable 204, the drawn air combines with the aerosol that is whisked, aspirated or otherwise drawn away from the electric heater and out the opening 348 in the mouth end of the aerosol provision system.

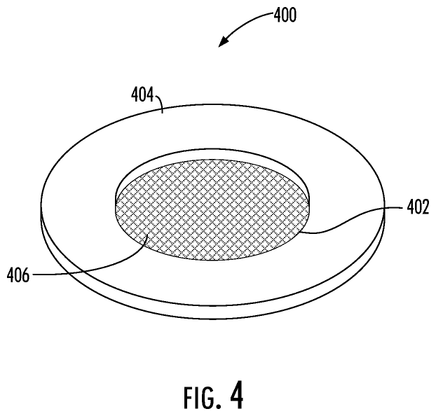

Again, as shown in FIGS. 2 and 3, the aerosol generator of the aerosol provision system 200 is an electric heater 306 designed to heat the aerosol-generating material 324 to generate an aerosol. In other implementations, the aerosol generator is designed to break up the aerosol-generating material without heating, or with only secondary heating. FIG. 4 illustrates a nebulizer 400 that may be used to implement the aerosol generator of an aerosol provision system, according to some these other example implementations.

As shown in FIG. 4, the nebulizer 400 includes a mesh plate 402 and a piezo material 404 that may be affixed to one another. The piezo material may be driven to vibrate and cause the mesh plate to break up aerosol-generating material into an aerosol. In some examples, the nebulizer may also include a supporting component located on a side of the mesh plate opposite the piezo material to increase the longevity of the mesh plate, and/or an auxiliary component between the mesh plate and the piezo material to facilitate interfacial contact between the mesh plate and the piezo material.

In various example implementations, the mesh plate 402 may have a variety of different configurations. The mesh plate may have a flat profile, a domed shape (concave or convex with respect to the aerosol-generating material), or a flat portion and a domed portion. The mesh plate defines a plurality of perforations 406 that may be substantially uniform or vary in size across a perforated portion of the mesh plate. The perforations may be circular openings or non-circular openings (e.g., oval, rectangular, triangular, regular polygon, irregular polygon). In three-dimensions, the perforations may have a fixed cross section such as in the case of cylindrical perforations with a fixed circular cross section, or a variable cross section such as in the case of truncated cone perforations with a variable circular cross section. In other implementations, the perforations may be tetragonal or pyramidal.

The piezo material 404 may be or include a piezoelectric material or a piezomagnetic material. A piezoelectric material may be coupled to circuitry configured to produce an oscillating electric signal to drive the piezoelectric material to vibrate. For a piezomagnetic material, the circuitry may produce a pair of antiphase, oscillating electric signals to drive a pair of magnets to produce antiphase, oscillating magnetic fields that drives the piezomagnetic material to vibrate.

The piezo material 404 may be affixed to the mesh plate 402, and vibration of the piezo material may in turn cause the mesh plate to vibrate. The mesh plate may be in contact with or immersed in aerosol-generating material, in sufficient proximity of aerosol-generating material, or may otherwise receive aerosol-generating material via an aerosol-generating material transfer component. The vibration of the mesh plate, then, may cause the aerosol-generating material to pass through the perforations 406 that break up the aerosol-generating material into an aerosol. More particularly, in some examples, aerosol-generating material may be driven through the perforations 406 in the vibrating mesh plate 402 resulting in aerosol particles. In other examples in which the mesh plate is in contact with or immersed in aerosol-generating material, the vibrating mesh plate may create ultrasonic waves within aerosol-generating material that cause formation of an aerosol at the surface of the aerosol-generating material.

As described above, hybrid products use a combination of aerosol-generating materials, and some hybrid products are similar to vapor products except that the aerosol generated from one aerosol-generating material may pass through a second aerosol-generating material to pick up additional constituents. Another similar aerosol provision system in the form of a hybrid product may therefore be constructed similar to the vapor product in FIGS. 2 and 3 (with an electric heater 306 or a nebulizer 400). The hybrid product may include a second aerosol-generating material through which aerosol from the aerosol-generating material 324 is passed to pick up additional constituents before passing through the opening 348 in the mouth end of the aerosol provision system.

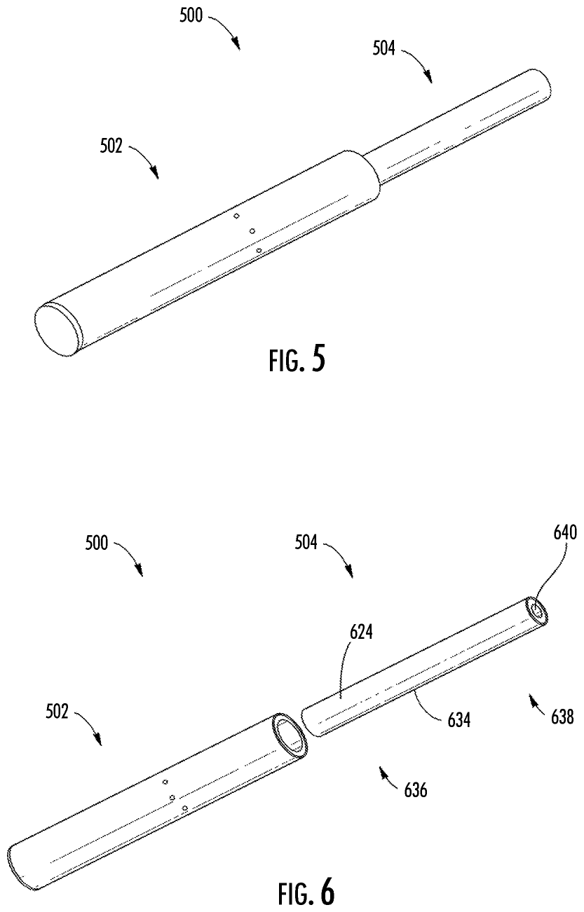

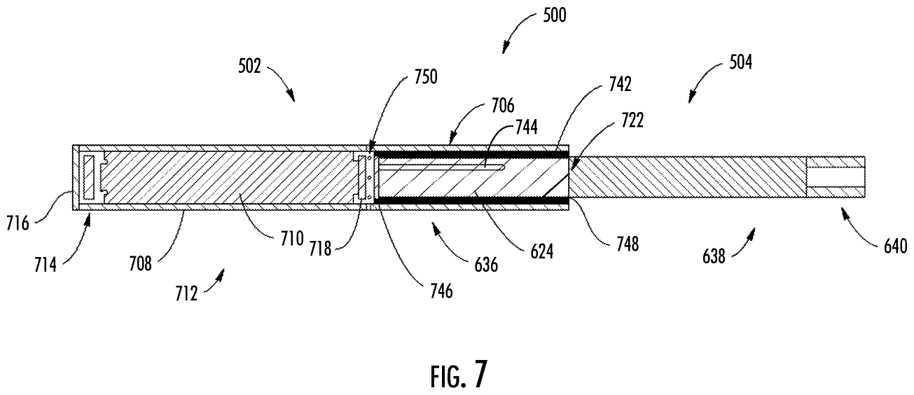

FIGS. 5, 6 and 7 illustrate an aerosol provision system 500 in the form of a heat-not-burn product, and that in some example implementations may correspond to the aerosol provision system 100. As shown, the aerosol provision system may include an aerosol provision device 502 (also referred to as a control body or power unit) and a consumable 504 (also referred to as an aerosol source member), which may correspond to respectively the aerosol provision device 102 and the consumable 104. The aerosol provision system and in particular the aerosol provision device may also include an aerosol generator corresponding to the aerosol generator 106, and in the form of an electric heater 706. The aerosol provision device and the consumable can be permanently or detachably aligned in a functioning relationship. FIG. 5 illustrates the aerosol provision system in a coupled configuration, whereas FIG. 6 illustrates the aerosol provision system in a decoupled configuration. FIG. 7 illustrates a partially cut-away side view of the aerosol provision system in the coupled configuration.

As seen in FIGS. 5, 6 and 7, the aerosol provision device 502 and consumable 504 each include a number of respective components. The components illustrated in the figures are representative of the components that may be present in an aerosol provision device and consumable and are not intended to limit the scope of components that are encompassed by the present disclosure.

The aerosol provision device 502 may include a housing 708 (sometimes referred to as an aerosol provision device shell) that may include a power source 710. The housing may also include circuitry 712 with a switch in the form of a sensor 714, a user interface including a light source 716 that may be illuminated with use of the aerosol provision system 500, and processing circuitry 718 (also referred to as a control component). In some examples, at least some of the electronic components of the circuitry may be formed of a circuit board or a flexible circuit board that supports and electrically connects the electronic components.

The housing 708 may also include a receptacle in the form of a consumable receiving chamber 722 structured to engage and hold the consumable 504. The consumable may include an aerosol-generating material 624 that may correspond to aerosol-generating material 124, and that may include one or more of each of a number of constituents such as an active substance, flavorant, aerosol-former material or other functional material. And the aerosol-generating material may be present on or in a support to form a substrate 634.

In the coupled configuration of the aerosol provision system 500, the consumable 504 may be held in the receiving chamber 722 in varying degrees. In some examples, less than half or approximately half of the consumable may be held in the receiving chamber. In other examples, more than half of the consumable may be held in the receiving chamber. In yet other examples, substantially the entire consumable may be held in the receiving chamber.

As shown in FIGS. 6 and 7, in various implementations of the present disclosure, the consumable 504 may include a heated end 636 sized and shaped for insertion into the aerosol provision device 502, and a mouth end 638 upon which a user draws to create the aerosol. In various implementations, at least a portion of the heated end may include the aerosol-generating material 624.

In some example implementations, the mouth end 608 of the consumable 504 may include a filter 640 made of a material such as cellulose acetate or polypropylene. The filter may additionally or alternatively contain strands of tobacco containing material. In some examples, at least a portion of the consumable may be wrapped in an exterior overwrap material, which may be formed of any material useful to provide additional structure, support and/or thermal resistance. In some examples, an excess length of the overwrap at the mouth end of the consumable may function to simply separate the aerosol-generating material 624 from the mouth of a user or to provide space for positioning of a filter material, or to affect draw on the consumable or to affect flow characteristics of the aerosol leaving the consumable during draw.

The electric heater 706 may perform electric heating of the aerosol-generating material 624 by resistance (Joule) heating, induction heating, dielectric and microwave heating, radiant heating, arc heating and the like. The electric heater may have a variety of different configurations. In some examples, at least a portion of the electric heater may surround or at least partially surround at least a portion of the consumable 504 including the aerosol-generating material when inserted in the aerosol provision device 502. In other examples, at least a portion of the electric heater may penetrate the consumable when the consumable is inserted into the aerosol provision device. In some examples, the substrate 634 material may include a susceptor, which may be embedded within the aerosol-generating material, or on one or either side of the aerosol-generating material.

Although shown as a part of the aerosol provision device 502, the electric heater 706 may instead be a part of the consumable 504. In some examples, the electric heater or a part of the electric heater may be combined, packaged or integral with (e.g., embedded within) the aerosol-generating material 624.

As shown, in some examples, the electric heater 706 may extend proximate an engagement end of the housing 708, and may be configured to substantially surround a portion of the heated end 636 of the consumable 504 that includes the aerosol-generating material 624. The electric heater 706 may be or may include an outer cylinder 742, and one or more resistive heating elements 744 such as prongs surrounded by the outer cylinder to create the receiving chamber 722, which may extend from a receiving base 746 of the aerosol provision device to an opening 748 of the housing 708 of the aerosol provision device. In some examples, the outer cylinder may be a double-walled vacuum tube constructed of stainless steel so as to maintain heat generated by the resistive heating element(s) within the outer cylinder, and more particularly, maintain heat generated by the resistive heating element(s) within the aerosol-generating material.

Like the electric heater 706, the resistive heating element(s) 744 may have a variety of different configurations, and vary in number from one resistive heating element to a plurality of resistive heating elements. As shown, the resistive heating element(s) may extend from a receiving base 746 of the aerosol provision device 502. In some examples, the resistive heating element(s) may be located at or around an approximate radial center of the heated end 636 of the consumable 504 when inserted into the aerosol provision device. In some examples, the resistive heating element(s) may penetrate into the heated end of the consumable and in direct contact with the aerosol-generating material. In other examples, the resistive heating element(s) may be located inside (but out of direct contact with) a cavity defined by an inner surface of the heated end of the consumable.

In some examples, the resistive heating element(s) 744 of the electric heater 706 may be connected in an electrical circuit that includes the power source 710 such that electric current produced by the power source may pass through the resistive heating element(s). The passage of the electric current through the resistive heating element(s) may in turn cause the resistive heating element(s) to produce heat through resistance (Joule) heating.

In other examples, the electric heater 706 including the outer cylinder 742 and the resistive heating element(s) 744 may be configured to perform induction heating in which the outer cylinder may be connected in an electrical circuit that includes the power source 710, and the resistive heating element(s) may be connected in another electrical circuit. In this configuration, the outer cylinder and resistive heating element(s) may function as a transformer in which the outer cylinder is an induction transmitter, and the resistive heating element(s) is/are an induction receiver. In some of these examples, the outer cylinder and the resistive heating element(s) may be part of the aerosol provision device 502. In other of these examples, the outer cylinder may be a part of the aerosol provision device, and the resistive heating element(s) may be a part of the consumable

The outer cylinder 730 may be provided an alternating current directly from the power source 710, or indirectly from the power source in which an inverter (as part of the circuitry 712) is configured to convert direct current from the power source to an alternating current. The alternating current drives the outer cylinder to generate an oscillating magnetic field, which induces eddy currents in the resistive heating element(s) 744. The eddy currents in turn cause the resistive heating element(s) to generate heat through resistance (Joule) heating. In these examples, the resistive heating element(s) may be wirelessly heated to form an aerosol from the aerosol-generating material 624 positioned in proximity to the resistive heating element(s).

In various example implementations, the aerosol provision device 502 may include an air intake 750 (e.g., one or more openings or apertures) in the housing 708 (and perhaps also the receiving base 746) to enable airflow into the receiving chamber 722. When a use draws on the mouth end 638 of the consumable 504, the airflow may be drawn through the air intake into the receiving chamber, pass into the consumable, and drawn through the aerosol-generating material 624. The airflow may be detected by the sensor 714, and the electric heater 706 may be activated to energize the aerosol-generating material to generate an aerosol. The airflow may combine with the aerosol that is whisked, aspirated or otherwise drawn out an opening at the mouth end of the aerosol provision system. In examples including the filter 640, the airflow combined with the aerosol may be drawn out an opening of the filter at the mouth end.

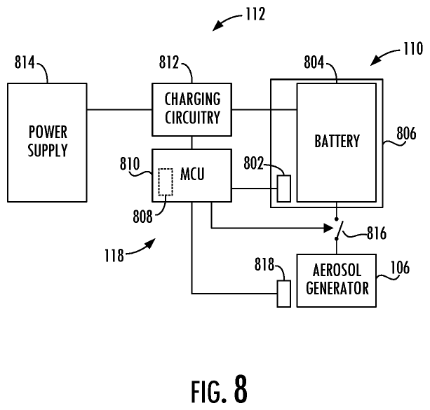

FIG. 8 further illustrates circuitry 112 of the aerosol provision device 102 of FIG. 1, according to some example implementations. Again, the aerosol provision device includes a power source, and the aerosol generator 106 may be powered by the power source to energize aerosol-generating material 124 to generate an aerosol for delivery to a user. As shown, the power source 110 includes a first temperature sensor 802 with which a temperature at the power source is measurable. In some examples, this temperature sensor may be a thermistor, and the power source includes one or more batteries 804 that are encased with the thermistor in a battery pack 806.

The processing circuitry 118 may be configured to control power to the aerosol generator 106 to energize the aerosol-generating material 124. Similar to the power source, the processing circuitry includes a second temperature sensor 808 with which the temperature at the processing circuitry is measurable. In some examples, the processing circuitry includes a microcontroller unit (MCU) 810 configured to control the power to the aerosol generator, and the second temperature sensor may be an internal temperature sensor of the MCU.

As also shown in FIG. 8, the aerosol provision device 102 may further include an additional temperature sensor 818, which may or may not be located as shown. In the depicted implementation, the additional temperature sensor may comprise a temperature sensor that is included with a use sensor configured to detect a draw on the device. In various implementations, a use sensor may be any sensor configured to detect a draw on the device, such as, for example, a pressure sensor and/or an airflow sensor. Other sensors are also possible. One particular example of a suitable sensor is a microelectromechanical systems (MEMS) pressure sensor configured to detect the process variable as a change in pressure caused by airflow when the user draws on the consumable. Suitable pressure sensors may include, but are not limited to, sensors LPS22HB or LPS22HH, available from STMicroelectronics NV, or the sensor BMP388, available from Bosch Sensortec GmbH. In some embodiments, the use sensor may be the only sensor configured to detect a draw on the device. In other implementations, the use sensor may be used on conjunction with another sensor, such as, for example, sensor 314 described above.

In other implementations, the additional sensor may comprise a sensor with which the temperature at the aerosol generator 106 is measurable. The processing circuitry 118 may be further configured to measure the temperature at the aerosol generator using the additional temperature sensor.

In addition to the control of power to the aerosol generator 106, the processing circuitry 118 may be configured to measure the temperature at the power source 110 using the first temperature sensor 802, the temperature at the processing circuitry using the second temperature sensor 808, and the temperature at the pressure sensor using the third temperature sensor 818. The processing circuitry may be configured to determine a temperature of the aerosol provision device 102 based on at least two of the following: (1) the temperature at the power source, (2) the temperature at the processing circuitry, and (3) the temperature at the pressure sensor. The processing circuitry may be further configured to control at least one device function based on the internal temperature of the aerosol provision device, and at least one threshold temperature. In various implementations, the determined temperature may be an internal temperature of the aerosol provision device, or an external temperature of the aerosol provision device, or both an internal temperature of the aerosol provision device and an external temperature of the aerosol provision device.

In various implementations, the device function may comprise any function of the aerosol provision device. For example, in some implementations, the device function may comprise either or both charging or discharging of the power source. In some implementations, the device function may comprise either or both powering the aerosol generator or suspending power to the aerosol generator. In some implementations, the device function may comprise a function of one or more user interfaces and/or one or more output devices, such as for example, one or more light-emitting diodes (LEDs), display devices, loudspeakers, vibration motors, etc. In other implementations, the device function may comprise other functions of the device, including, for example, data processing.

In some examples, the circuitry 112 of the aerosol provision device 102 may include charging circuitry 812 configured to switchably interconnect the power source 110 and a power supply 814 from which the power source may be charged (or recharged). The circuitry may include a switch 816 such as a high-side load switch to switchably interconnect the power source and the aerosol generator 106 to which the power source may be discharged (and the aerosol generator thereby powered). In some of these examples, the processing circuitry 118 configured to control charging of the power source may include the processing circuitry configured to control the charging circuitry to enable or disable the charging of the power source. Similarly, the processing circuitry configured to control discharging of the power source may include the processing circuitry configured to control the switch to enable or disable the discharging of the power source.

The at least one threshold temperature may be expressed in a number of different manners. In some examples, the at least one threshold temperature may be expressed as at least one threshold temperature range. In some examples, then, the processing circuitry 118 may be configured to enable the charging (e.g., by control of the charging circuitry 812) when the internal temperature of the aerosol provision device 102 is within the at least one threshold temperature range, and disable the charging when the internal temperature is outside the at least one threshold temperature range. Similarly, in some examples, the processing circuitry may be configured to enable the discharging (e.g., by control of switch 816) when the internal temperature of the aerosol provision device is within the at least one threshold temperature range, and disable the discharging when the internal temperature is outside the at least one threshold temperature range.

In some examples, the at least one threshold temperature includes a first threshold temperature and a second threshold temperature that are different from one another. In some of these examples, the processing circuitry 118 may be configured to control the charging of the power source 110 based on the first threshold temperature, and control the discharging of the power source based on the second threshold temperature.

In some further examples, the first threshold temperature may be expressed as a first threshold temperature range, and the second threshold temperature may be expressed as a second threshold temperature range. Control of the charging, then, may include the processing circuitry 118 configured to enable the charging when the internal temperature of the aerosol provision device 102 is within the first threshold temperature range, and disable the charging when the internal temperature is outside the first threshold temperature range. And control of the discharging may include the processing circuitry configured to enable the discharging when the internal temperature of the aerosol provision device is within the second threshold temperature range, and disable the discharging when the internal temperature is outside the second threshold temperature range.

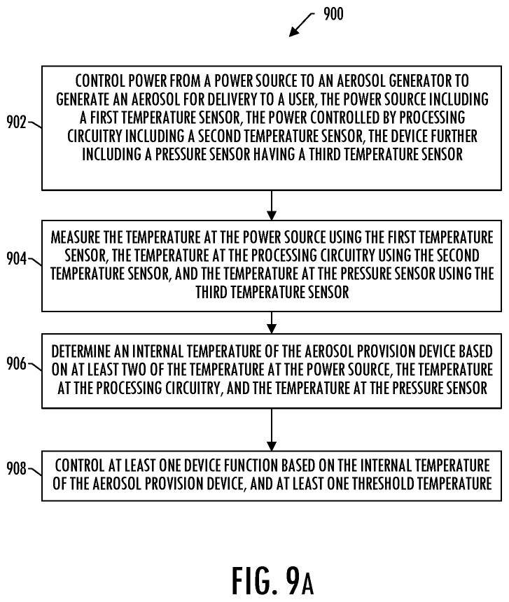

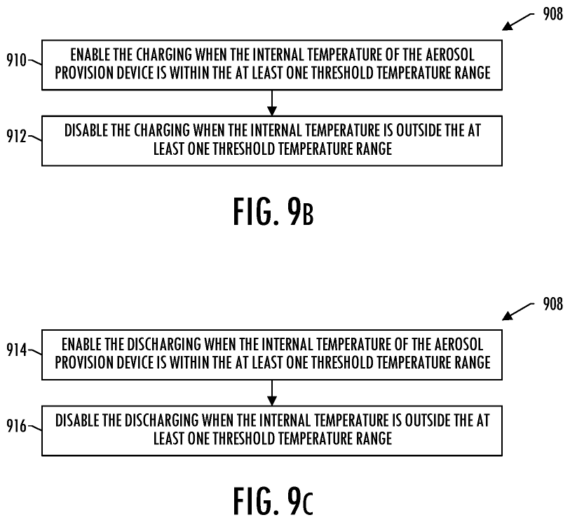

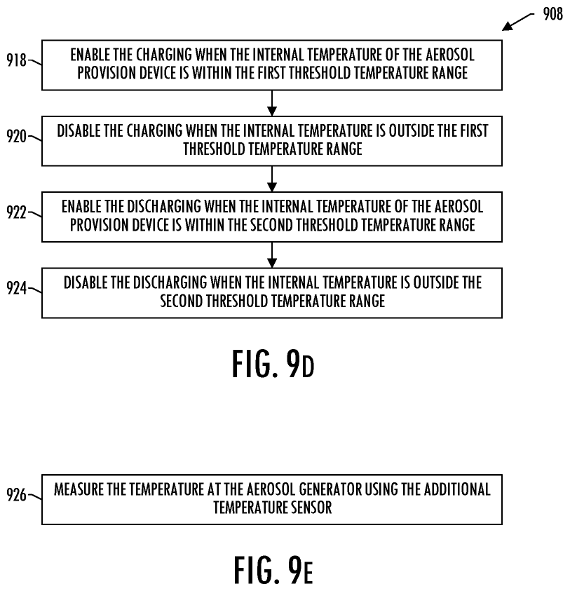

FIGS. 9A-9E are flowcharts illustrating various steps in a method 900 of operating an aerosol provision device, according to various example implementations of the present disclosure. The method includes controlling power from a power source to an aerosol generator to energize an aerosol-generating material of a consumable to generate an aerosol for delivery to a user, as shown at block 902 of FIG. 9A. The power source includes a temperature sensor with which a temperature at the power source is measurable, and the power controlled by processing circuitry includes a second temperature sensor with which the temperature at the processing circuitry is measurable. The method further includes the processing circuitry measuring the temperature at the power source using the temperature sensor, and the temperature at the processing circuitry using the second temperature sensor, as shown at block 904. The method includes the processing circuitry determining an internal temperature of the aerosol provision device based on the temperature at the power source, and the temperature at the processing circuitry, as shown at block 906. And the method includes the processing circuitry controlling charging or discharging of the power source based on the internal temperature of the aerosol provision device, and at least one threshold temperature, as shown at block 908. It should be noted that although in the example implementation illustrated in FIGS. 9A-9E the determined temperature of the aerosol provision device comprises an an internal temperature of the aerosol provision device, in other example implementations, the determined temperature may be an external temperature of the aerosol provision device or both an internal termperature of the aerosol provision device and an external temperature of the aerosol provision device.

In some examples, the temperature sensor of the power source is a thermistor, and the power source includes one or more batteries that are encased with the thermistor in a battery pack. An some examples, the processing circuitry includes a microcontroller unit (MCU) that controls the power to the aerosol generator, and the second temperature sensor is an internal temperature sensor of the MCU.

In some examples, the at least one threshold temperature is expressed as at least one threshold temperature range. FIGS. 9B-9C illustrate one example implementation in which the at least one device function comprises enabling and disabling charging and discharging of the power source. In some of these examples, the charging of the power source is controlled at block 908, and includes enabling the charging when the internal temperature of the aerosol provision device is within the at least one threshold temperature range, and disabling the charging when the internal temperature is outside the at least one threshold temperature range, as shown at blocks 910 and 912 of FIG. 9B. Similarly, in some examples, the discharging of the power source is controlled at block 908, and includes enabling the discharging when the internal temperature of the aerosol provision device is within the at least one threshold temperature range, and disabling the discharging when the internal temperature is outside the at least one threshold temperature range, as shown at blocks 914 and 916 of FIG. 9C.

In some examples, both the charging and the discharging of the power source are controlled at block 908 based on the internal temperature of the aerosol provision device. In some of these examples, the at least one threshold temperature includes a first threshold temperature and a second threshold temperature that are different from one another. The charging of the power source is controlled based on the first threshold temperature, and the discharging of the power source is controlled based on the second threshold temperature.

In some examples, the first threshold temperature is expressed as a first threshold temperature range, and the second threshold temperature is expressed as a second threshold temperature range. In some of these examples, control of the charging at block 908 includes enabling the charging when the internal temperature of the aerosol provision device is within the first threshold temperature range, and disabling the charging when the internal temperature is outside the first threshold temperature range, as shown at blocks 918 and 920 of FIG. 9D. And control of the discharging includes enabling the discharging when the internal temperature of the aerosol provision device is within the second threshold temperature range, and disabling the discharging when the internal temperature is outside the second threshold temperature range, as shown at blocks 922 and 924.

In some examples, the aerosol provision device further includes an additional temperature sensor with which the temperature at the aerosol generator is measurable. In some of these examples, the method further includes the processing circuitry measuring the temperature at the aerosol generator using the additional temperature sensor, as shown at block 926 of FIG. 9E. The internal temperature of the aerosol provision device, then, is determined at block 906 further based on the temperature at the aerosol generator.

As explained above and reiterated below, the present disclosure includes, without limitation, the following example implementations.

Example Implementation 1: An aerosol provision device comprising: a power source including a first temperature sensor with which a temperature at the power source is measurable; an aerosol generator powered by the power source to generate an aerosol from an aerosol-generating material for delivery to a user; processing circuitry configured to control power to the aerosol generator, the processing circuitry including a second temperature sensor with which the temperature at the processing circuitry is measurable, a use sensor configured to detect a draw on the device, the use sensor including a third temperature sensor with which temperature at the use sensor is measurable; the processing circuitry further configured to at least: measure the temperature at the power source using the first temperature sensor, measure the temperature at the processing circuitry using the second temperature sensor, and measure the temperature at the use sensor using the third temperature sensor; determine a temperature of the aerosol provision device based on at least two of: the temperature measured by the first temperature sensor, the temperature measured by the second temperature sensor, and the temperature measured by the third temperature sensor; and control at least one device function based on the determined temperature of the aerosol provision device, and at least one threshold temperature.

Example Implementation 2: The aerosol provision device of Example Implementation Example Implementation 1:, or any combination of preceding example implementations, wherein the determined temperature comprises an internal temperature of the aerosol provision device.

Example Implementation 3: The aerosol provision device of any one of Example Implementations 1-2, or any combination of preceding example implementations, wherein the first temperature sensor is a thermistor, and the power source includes one or more batteries that are encased with the thermistor in a battery pack.

Example Implementation 4: The aerosol provision device of any one of Example Implementations 1-3, or any combination of preceding example implementations, wherein the processing circuitry includes a microcontroller unit (MCU) configured to control the power to the aerosol generator, and the second temperature sensor is an internal temperature sensor of the MCU.

Example Implementation 5: The aerosol provision device of any one of Example Implementations 1-4, or any combination of preceding example implementations, wherein the use sensor is a microelectromechanical systems (MEMS) pressure sensor.

Example Implementation 6: The aerosol provision device of any one of Example Implementations 1-5, or any combination of preceding example implementations, wherein the at least one threshold temperature is expressed as at least one threshold temperature range.

Example Implementation 7: The aerosol provision device of any one of Example Implementations 1-6, or any combination of preceding example implementations, wherein the at least one device function comprises charging of the power source, wherein control of charging of the power source includes the processing circuitry configured to enable the charging when the determined temperature of the aerosol provision device is within the at least one threshold temperature range, and disable the charging when the determined temperature is outside the at least one threshold temperature range.

Example Implementation 8: The aerosol provision device of any one of Example Implementations 1-7, or any combination of preceding example implementations, wherein the at least one device function comprises discharging of the power source, wherein control of discharging of the power source includes the processing circuitry configured to enable the discharging when the determined temperature of the aerosol provision device is within the at least one threshold temperature range, and disable the discharging when the determined temperature is outside the at least one threshold temperature range.

Example Implementation 9: The aerosol provision device of any one of Example Implementations 1-8, or any combination of preceding example implementations, wherein the processing circuitry is configured to control both the charging and the discharging of the power source based on the determined temperature of the aerosol provision device.

Example Implementation 10: The aerosol provision device of any one of Example Implementations 1-9, or any combination of preceding example implementations, wherein the at least one threshold temperature includes a first threshold temperature and a second threshold temperature that are different from one another, and wherein the processing circuitry is configured to control the charging of the power source based on the first threshold temperature, and control the discharging of the power source based on the second threshold temperature.

Example Implementation 11: The aerosol provision device of any one of Example Implementations 1-10, or any combination of preceding example implementations, wherein the first threshold temperature is expressed as a first threshold temperature range, and the second threshold temperature is expressed as a second threshold temperature range.

Example Implementation 12: The aerosol provision device of any one of Example Implementations 1-11, or any combination of preceding example implementations, wherein control of the charging includes the processing circuitry configured to enable the charging when the determined temperature of the aerosol provision device is within the first threshold temperature range, and disable the charging when the determined temperature is outside the first threshold temperature range, and wherein control of the discharging includes the processing circuitry configured to enable the discharging when the determined temperature of the aerosol provision device is within the second threshold temperature range, and disable the discharging when the determined temperature is outside the second threshold temperature range.

Example 13: The aerosol provision device of any one of Example Implementations 1-12, or any combination of preceding example implementations, wherein the at least one device function comprises energizing the aerosol-generating material, wherein control of energizing the aerosol-generating material includes the processing circuitry configured to energize the aerosol-generating material when the determined temperature of the aerosol provision device is within the at least one threshold temperature range, and disable energizing the aerosol-generating material when the determined temperature of the aerosol provision device is outside the at least one threshold temperature range.

Example Implementation 14: The aerosol provision device of any one of Example Implementations 1-13, or any combination of preceding example implementations, wherein the aerosol-generating material is contained in a consumable configured to be coupled to the device.

Example Implementation 15: A method of operating an aerosol provision device, the method comprising: controlling power from a power source to an aerosol generator to energize an aerosol-generating material to generate an aerosol for delivery to a user, the power source including a first temperature sensor with which a temperature at the power source is measurable, the power controlled by processing circuitry including a second temperature sensor with which the temperature at the processing circuitry is measurable, the aerosol provision device further including a use sensor configured to detect a draw on the device, the use sensor including a third temperature sensor with which temperature at the use sensor is measurable, and further by the processing circuitry, measuring a temperature at the power source using the first temperature sensor, measuring a temperature at the processing circuitry using the second temperature sensor, and measuring a temperature at the use sensor using the third temperature sensor; determining a temperature of the aerosol provision device based on at least two of: the temperature at the power source, the temperature at the processing circuitry, and the temperature at the use sensor; and controlling at least one device function based on the determined temperature of the aerosol provision device, and at least one threshold temperature.

Example Implementation 16: The method of Example Implementation 15, or any combination of preceding example implementations, wherein the determined temperature comprises an internal temperature of the aerosol provision device.

Example Implementation 17: The method of any one of Example Implementations 15-16, or any combination of preceding example implementations, wherein the first temperature sensor is a thermistor, and the power source includes one or more batteries that are encased with the thermistor in a battery pack.

Example Implementation 18: The method of any one of Example Implementations 15-17, or any combination of preceding example implementations, wherein the processing circuitry includes a microcontroller unit (MCU) that controls the power to the aerosol generator, and the second temperature sensor is an internal temperature sensor of the MCU.

Example Implementation 19: The method of any one of Example Implementations 15-18, or any combination of preceding example implementations, wherein the use sensor is a microelectromechanical systems (MEMS) pressure sensor.

Example Implementation 20: The method of any one of Example Implementations 15-19, or any combination of preceding example implementations, wherein the at least one threshold temperature is expressed as at least one threshold temperature range.

Example Implementation 21: The method of any one of Example Implementations 15-20, wherein the at least one device function comprises charging of the power source, and includes enabling the charging when the determined temperature of the aerosol provision device is within the at least one threshold temperature range, and disabling the charging when the determined temperature is outside the at least one threshold temperature range.

Example Implementation 22: The method of any one of Example Implementations 15-21, or any combination of preceding example implementations, wherein the at least one device function comprises discharging of the power source is controlled, and includes enabling the discharging when the determined temperature of the aerosol provision device is within the at least one threshold temperature range, and disabling the discharging when the determined temperature is outside the at least one threshold temperature range.

Example Implementation 23: The method of any one of Example Implementations 15-22, wherein both the charging and the discharging of the power source are controlled based on the determined temperature of the aerosol provision device.

Example Implementation 24: The method of any one of Example Implementations 15-23, or any combination of preceding example implementations, wherein the at least one threshold temperature includes a first threshold temperature and a second threshold temperature that are different from one another, and wherein the charging of the power source is controlled based on the first threshold temperature, and the discharging of the power source is controlled based on the second threshold temperature.

Example Implementation 25: The method of any one of Example Implementations 15-24, or any combination of preceding example implementations, wherein the first threshold temperature is expressed as a first threshold temperature range, and the second threshold temperature is expressed as a second threshold temperature range.

Example Implementation 26: The method of any one of Example Implementations 15-25, or any combination of preceding example implementations, wherein control of the charging includes enabling the charging when the determined temperature of the aerosol provision device is within the first threshold temperature range, and disabling the charging when the determined temperature is outside the first threshold temperature range, and wherein control of the discharging includes enabling the discharging when the determined temperature of the aerosol provision device is within the second threshold temperature range, and disabling the discharging when the determined temperature is outside the second threshold temperature range.

Example Implementation 27: The method of any one of Example Implementations 15-26, or any combination of preceding example implementations, wherein the at least one device function comprises energizing the aerosol-generating material, and includes energizing the aerosol-generating material when the determined temperature of the aerosol provision device is within the at least one threshold temperature range, and disabling energizing the aerosol-generating material when the determined temperature is outside the at least one threshold temperature range.

Many modifications and other implementations of the disclosure will come to mind to one skilled in the art to which this disclosure pertains having the benefit of the teachings presented in the foregoing descriptions and the associated figures. Therefore, it is to be understood that the disclosure is not to be limited to the specific implementations disclosed herein and that modifications and other implementations are intended to be included within the scope of the appended claims. Although specific terms are employed herein, they are used in a generic and descriptive sense only and not for purposes of limitation.

What is claimed is:

1. An aerosol provision device comprising:
a power source including a first temperature sensor with which a temperature at the power source is measurable;
an aerosol generator powered by the power source to generate an aerosol from an aerosol-generating material for delivery to a user;
processing circuitry configured to control power to the aerosol generator, the processing circuitry including a second temperature sensor with which the temperature at the processing circuitry is measurable,
a use sensor configured to detect a draw on the device, the use sensor including a third temperature sensor with which temperature at the use sensor is measurable;
the processing circuitry further configured to at least:
measure the temperature at the power source using the first temperature sensor, measure the temperature at the processing circuitry using the second temperature sensor, and measure the temperature at the use sensor using the third temperature sensor;
determine a temperature of the aerosol provision device based on at least two of: the temperature measured by the first temperature sensor, the temperature measured by the second temperature sensor, and the temperature measured by the third temperature sensor; and
control at least one device function based on the determined temperature of the aerosol provision device, and at least one threshold temperature.

2. The aerosol provision device of claim 1, wherein the determined temperature comprises an internal temperature of the aerosol provision device.

3. The aerosol provision device of claim 1, wherein the first temperature sensor is a thermistor, and the power source includes one or more batteries that are encased with the thermistor in a battery pack.

4. The aerosol provision device of claim 1, wherein the processing circuitry includes a microcontroller unit (MCU) configured to control the power to the aerosol generator, and the second temperature sensor is an internal temperature sensor of the MCU.

5. The aerosol provision device of claim 1, wherein the use sensor is a microelectromechanical systems (MEMS) pressure sensor.

6. The aerosol provision device of claim 1, wherein the at least one threshold temperature is expressed as at least one threshold temperature range.

7. The aerosol provision device of claim 6, wherein the at least one device function comprises charging of the power source, wherein control of charging of the power source includes the processing circuitry configured to enable the charging when the determined temperature of the aerosol provision device is within the at least one threshold temperature range, and disable the charging when the determined temperature is outside the at least one threshold temperature range.

8. The aerosol provision device of claim 6, wherein the at least one device function comprises discharging of the power source, wherein control of discharging of the power source includes the processing circuitry configured to enable the discharging when the determined temperature of the aerosol provision device is within the at least one threshold temperature range, and disable the discharging when the determined temperature is outside the at least one threshold temperature range.

9. The aerosol provision device of claim 1, wherein the processing circuitry is configured to control both the charging and the discharging of the power source based on the determined temperature of the aerosol provision device.

10. The aerosol provision device of claim 9, wherein the at least one threshold temperature includes a first threshold temperature and a second threshold temperature that are different from one another, and
wherein the processing circuitry is configured to control the charging of the power source based on the first threshold temperature, and control the discharging of the power source based on the second threshold temperature.

11. The aerosol provision device of claim 10, wherein the first threshold temperature is expressed as a first threshold temperature range, and the second threshold temperature is expressed as a second threshold temperature range.

12. The aerosol provision device of claim 11, wherein control of the charging includes the processing circuitry configured to enable the charging when the determined temperature of the aerosol provision device is within the first threshold temperature range, and disable the charging when the determined temperature is outside the first threshold temperature range, and
wherein control of the discharging includes the processing circuitry configured to enable the discharging when the determined temperature of the aerosol provision device is within the second threshold temperature range, and disable the discharging when the determined temperature is outside the second threshold temperature range.

13. The aerosol provision device of claim 6, wherein the at least one device function comprises energizing the aerosol generator, wherein control of energizing the aerosol generator includes the processing circuitry configured to energize the aerosol generator when the determined temperature of the aerosol provision device is within the at least one threshold temperature range, and disable energizing the aerosol generator when the determined temperature of the aerosol provision device is outside the at least one threshold temperature range.

14. The aerosol provision device of claim 1, wherein the aerosol-generating material is contained in a consumable configured to be coupled to the device.

15. A method of operating an aerosol provision device, the method comprising:
controlling power from a power source to an aerosol generator to generate an aerosol from an aerosol-generating material for delivery to a user, the power source including a first temperature sensor with which a temperature at the power source is measurable, the power controlled by processing circuitry including a second temperature sensor with which the temperature at the processing circuitry is measurable, the aerosol provision device further including a use sensor configured to detect a draw on the device, the use sensor including a third temperature sensor with which temperature at the use sensor is measurable, and further by the processing circuitry,
measuring a temperature at the power source using the first temperature sensor, measuring a temperature at the processing circuitry using the second temperature sensor, and measuring a temperature at the use sensor using the third temperature sensor;
determining a temperature of the aerosol provision device based on at least two of: the temperature at the power source, the temperature at the processing circuitry, and the temperature at the use sensor; and
controlling at least one device function based on the determined temperature of the aerosol provision device, and at least one threshold temperature.

16. The method of claim 15, wherein the determined temperature comprises an internal temperature of the aerosol provision device.

17. The method of claim 15, wherein the first temperature sensor is a thermistor, and the power source includes one or more batteries that are encased with the thermistor in a battery pack.

18. The method of claim 15, wherein the processing circuitry includes a microcontroller unit (MCU) that controls the power to the aerosol generator, and the second temperature sensor is an internal temperature sensor of the MCU.

19. The method of claim 15, wherein the use sensor is a microelectromechanical systems (MEMS) pressure sensor.

20. The method of claim 15, wherein the at least one threshold temperature is expressed as at least one threshold temperature range.

21. The method of claim 20, wherein the at least one device function comprises charging of the power source, and includes enabling the charging when the determined temperature of the aerosol provision device is within the at least one threshold temperature range, and disabling the charging when the determined temperature is outside the at least one threshold temperature range.

22. The method of claim 20, wherein the at least one device function comprises discharging of the power source is controlled, and includes enabling the discharging when the determined temperature of the aerosol provision device is within the at least one threshold temperature range, and disabling the discharging when the determined temperature is outside the at least one threshold temperature range.

23. The method of claim 15, wherein both the charging and the discharging of the power source are controlled based on the determined temperature of the aerosol provision device.

24. The method of claim 23, wherein the at least one threshold temperature includes a first threshold temperature and a second threshold temperature that are different from one another, and
wherein the charging of the power source is controlled based on the first threshold temperature, and the discharging of the power source is controlled based on the second threshold temperature.

25. The method of claim 24, wherein the first threshold temperature is expressed as a first threshold temperature range, and the second threshold temperature is expressed as a second threshold temperature range.

26. The method of claim 25, wherein control of the charging includes enabling the charging when the determined temperature of the aerosol provision device is within the first threshold temperature range, and disabling the charging when the determined temperature is outside the first threshold temperature range, and
wherein control of the discharging includes enabling the discharging when the determined temperature of the aerosol provision device is within the second threshold temperature range, and disabling the discharging when the determined temperature is outside the second threshold temperature range.

27. The method of claim 20, wherein the at least one device function comprises energizing the aerosol generator, and includes energizing the aerosol generator when the determined temperature of the aerosol provision device is within the at least one threshold temperature range, and disabling energizing the aerosol generator when the determined temperature is outside the at least one threshold temperature range.
